(19) United States
(12) Patent Application Publication
(10) Pub. No.: US 2009/0112964 A1
(43) Pub. Date: Apr. 30, 2009

(54) DEVICES, METHODS, AND COMPUTER READABLE MEDIA FOR WIRELESS ADAPTER DISENGAGEMENT CONTROL

(75) Inventors: MATTHEW MCGLONE, SUNRISE, FL (US); JOHN BEGENS, WELLINGTON, FL (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/926,725

(22) Filed: Oct. 29, 2007

(51) Int. Cl. G06F 15/16

(52) U.S. Cl. 709/200

(57) ABSTRACT

Disclosed are devices, methods and computer readable media including a wireless adapter disengagement control that is configured to disengage at least most of the wireless communication when several conditions are met. A wired communication detector detects that a wired communication connector is in communication with a wired network, and an event registration control detects an event. The event is a trigger for determining whether the device is simultaneously in communication with a wired network and consuming system resources associated with wireless communication. By using an event as a trigger for the determination of whether the device is simultaneously in communication with a wired network and consuming system resources associated with wireless communication, the disclosed devices and methods beneficially add no additional background processes to the operation of the device, and require no additional configuration to the device.

### FIELD

Disclosed are devices, methods, and computer readable media for wireless adapter disengagement control, and more particularly, for automatic wireless adapter disengagement control when particular conditions are met.

### BACKGROUND

New computing devices, such as computers, are equipped with both wired network adapters and wireless network adapters. The wired network adapters can connect a computer via a cable to an Ethernet network. Ethernet is a family of frame-based computer networking technologies for local area networks (LANs). A wired network adapter could alternatively or in addition connect via, for example, a USB connector and cable to a router. Wireless network adapters can connect a computer via a transceiver to a Wireless Local Area Networks (WLANs), such as a Wireless Fidelity (WiFi) network.

WLANs are becoming compatible with many different types of products. While businesses originally installed WLANs so that desktop computers could be used on networks without expensive wiring, the functionality of the WLANs has evolved to allow mobile communication devices, such as wireless telephones, laptop computers, personal digital assistants (PDAs) and digital cameras to connect to WLANs for Internet access and wireless Voice over Internet Protocol (VOIP) telephone service.

A WiFi enabled device can connect to a WLAN when near one of the network's wireless access points (WAPs or APs). Within the range of an access point, a wireless end-user has a full network connection with the benefit of mobility within the area covered by the WAP. The geographic region covered by one or more access points is called a hotspot. The range of access points can vary as can the distance between them. While a wireless connection is beneficial in many ways, a wired connection is faster and has a broader bandwidth than a WiFi connection.

During events such as power up, the wireless network adapter will automatically become operational in accordance with network connection algorithms, whether or not a user has connected a wired network cable to the computing device. The computing device will therefore maintain the wireless connection, running slower than it would were the wired connection operational. Moreover, when the wireless connection is needlessly operational, overall WiFi resources are consumed without benefit. To discontinue the wireless communication, a user is required to observe that the wireless network adapter is operational, typically by an icon on the user's display, and then manually disengage the wireless communication.

### BRIEF DESCRIPTION OF THE DRAWINGS

FIG. 1 depicts an electronic device, and more particularly, a computing device such as a computer that is equipped with both a wired network adapter and a wireless network adapter;

FIG. 2 illustrates a device and various hardware and/or software components of its central processing unit (CPU) including a wired communication detector, a wireless adapter disengagement control, and an event registration control to detect an event that will activate the wireless adapter disengagement control; and

FIG. 3 depicts a method of a computer readable medium having computer executable instructions for performing a method of an electronic device to disengage at least most of the wireless communication when the wired communication detector detects that the wired communication connector is in communication with a wired network, and an event registration control detects an event.

### DETAILED DESCRIPTION

It would be beneficial when a device is in wired communication with a wired network, that the device is not simultaneously consuming system resources associated with wireless communication. It would be further beneficial were a user not required to observe that the device is simultaneously in communication with a wired network and a wireless communication in order to manually disengage the wireless communication. In such a situation, it would also be beneficial were a wireless network adapter to automatically be disabled so that the user need not manually disable the wireless network adapter, assuming that the user would prefer the communication over a wired network since it is faster and has a higher bandwidth than a wireless connection. Otherwise a user may not have made the wired connection by plugging in a wired communication cable to the device. Accordingly, the system resources and overall wireless network resources may be conserved.

Disclosed are devices, methods and computer readable media including a wireless adapter disengagement control that is configured to disable the wireless network adapter and/or disengage at least most of the wireless communication when particular conditions are met. That is, the wireless network adapter need not be entirely disabled when at least most of the wireless communication is disengaged. The conditions include that a wired communication detector detects that the wired communication connector is in communication with a wired network, and an event registration control detects a registered event. The registered event is a trigger for determining whether the device is in wired communication. If the device is simultaneously in communication with both a wired network and consuming system resources associated with wireless communication, the wireless adapter can be disengaged. A registered event may include for example, connection of the wired communication connector to a wired network, power up of the device, resuming operation of the device from hibernation, resuming operation of the device from standby, a predetermined task startup, and a user defined predetermined event. By using a registered event as a trigger for the determination of whether the device is in communication with a wired network the consumption of system resources associated with wireless communication may be eliminated. The disclosed devices and method beneficially do not add any additional background processes to the operation of the device, and do not require additional configuration to the device.

The instant disclosure is provided to explain in an enabling fashion the best modes of making and using various embodiments in accordance with the present invention. The disclosure is further offered to enhance an understanding and appreciation for the invention principles and advantages thereof, rather than to limit in any manner the invention. While the preferred embodiments of the invention are illustrated and described here, it is clear that the invention is not so limited. Numerous modifications, changes, variations, substitutions, and equivalents will occur to those skilled in the art having the benefit of this disclosure without departing from the spirit and scope of the present invention as defined by the following claims.

It is understood that the use of relational terms, if any, such as first and second, up and down, and the like are used solely to distinguish one from another entity or action without necessarily requiring or implying any actual such relationship or order between such entities or actions.

Much of the inventive functionality and many of the inventive principles are best implemented with or in software programs or instructions and integrated circuits (ICs) such as application specific ICs. In the interest of brevity and minimization of any risk of obscuring the principles and concepts according to the present invention, discussion of such software and ICs, if any, is limited to the essentials with respect to the principles and concepts within the preferred embodiments.

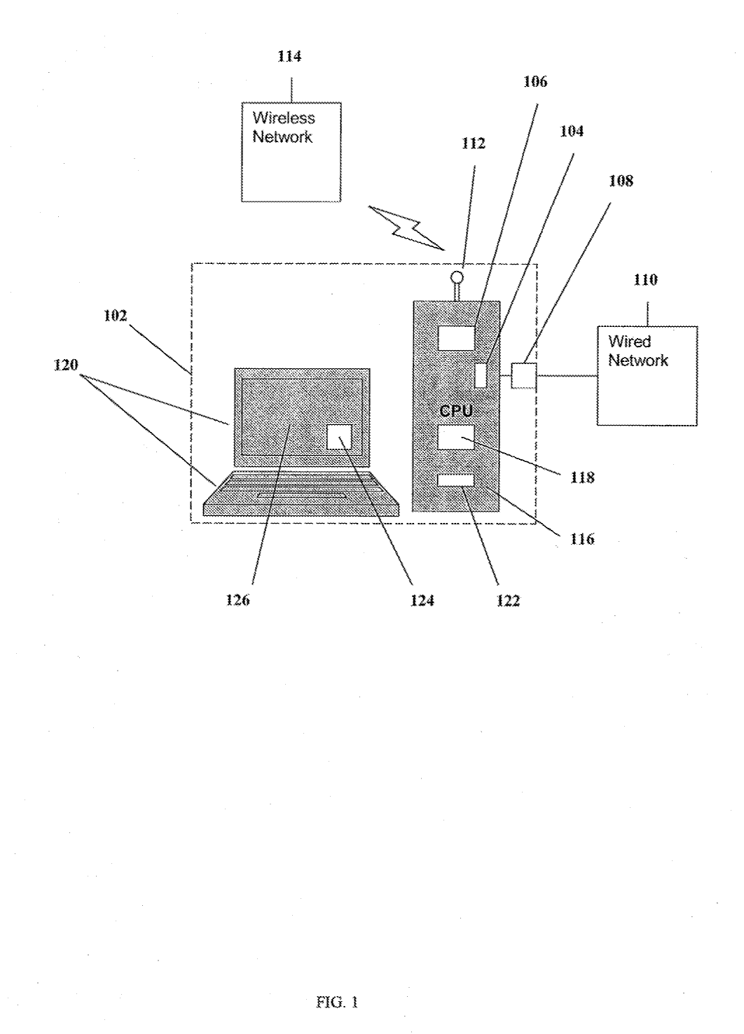

FIG. 1 depicts an electronic device, and more particularly, a computing device such as a computer that is equipped with both a wired network adapter and a wireless network adapter. The electronic device 102 may be any type of device that includes both a wired network adapter 104 and a wireless network adapter 106, including a mobile communication device. The wired network adapter 104 may be connected by a connector 108 including a cable to a wired network 110. The wireless network adapter 106 may include a transceiver 112, and may be connected by the transceiver to a wireless network 114. The central processing unit (CPU) 116 may include a controller 118 to process the below-described process of disabling the wireless network adapter 106 and/or disengaging at least most of the wireless communication when particular conditions are met. That is, the wireless network adapter 106 need not be entirely disabled when at least most of the wireless communication is disengaged. The conditions include detecting that the wired communication connector is in communication with a wired network, and detecting a registered event. The event may be an event registered with an event registration control, as explained below. In addition to determining if there is a wired connection and if a registered event occurs, the conditions may further optionally include detecting that there is wireless communication with a wireless network.

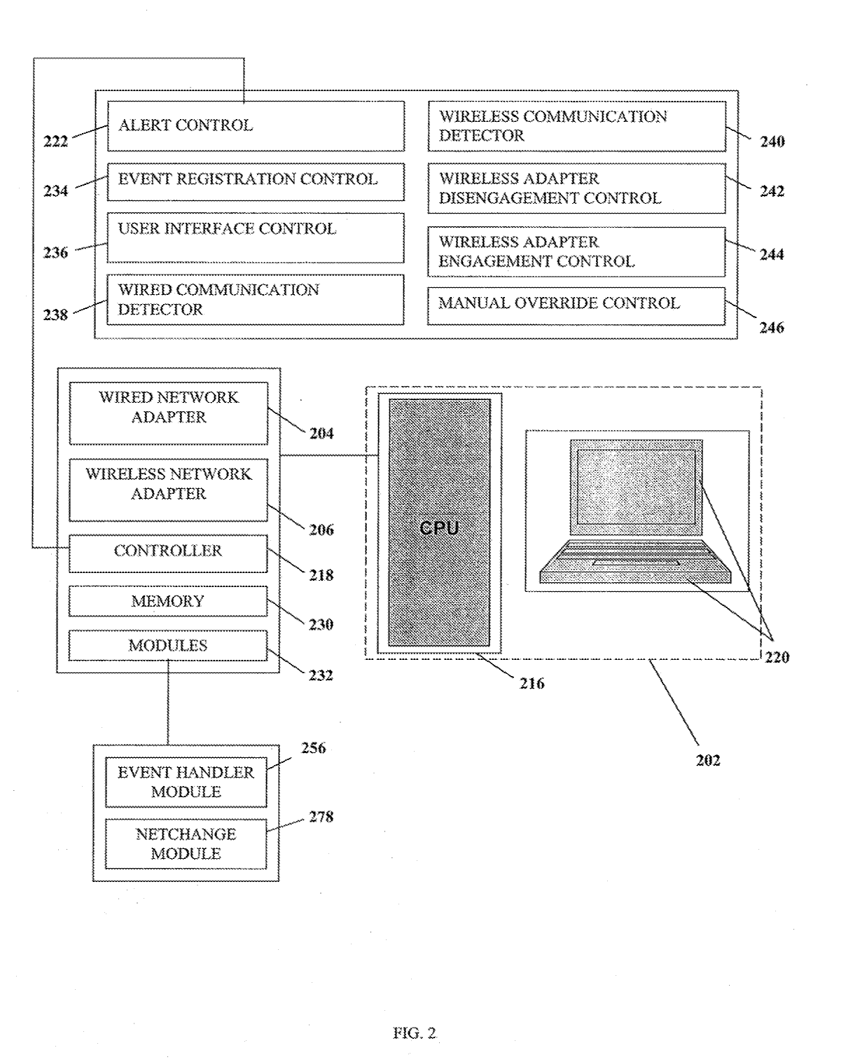

Once the above described dual conditions have been met and the wireless network adapter 106 has been disabled, the user interface 120 of the device may provide an indication that the wireless network adapter has been disabled. In the event that a user would prefer to use the wireless network, an alert may be beneficial for the user to know the status of network connections. Accordingly, an alert control 122 may be coupled to the controller 118, the alert control 122 configured for notification 124 of the disengagement from the wireless network 114, and/or for disabling of the wireless network adapter 106. Alternatively, in the event that the wired connector is disengaged, a wireless adapter engagement control (see FIG. 2, below) can be configured to enable the wireless communication transceiver 112 when a wireless communication detector (see FIG. 2) detects that the wired communication connector 108 is not in communication with a wired network 110. In that case, the alert control 122 may be configured for notification 124 that the wireless adapter engagement control has been activated. The notification 124 can be in any form, such as an icon on the display screen 126 of the user interface 120. For example, the notification may be an audible alert.

FIG. 2 illustrates a device and various hardware and software components of its central processing unit (CPU) including a wired communication detector, a wireless adapter disengagement control, and an event registration control to detect an event that will activate the wireless adapter disengagement control. In more detail, FIG. 2 illustrates a device 202 (similar to that depicted as device 102 in FIG. 1) and various components of the CPU 216 including a wireless adapter disengagement control 242 that is configured to disable the wireless network adapter 106 when conditions are met. In an embodiment, the wireless adapter disengagement control 242 is configured to disengage at least most of the wireless communication when conditions are met. That is, the wireless network adapter 106 need not be entirely disabled when at least most of the wireless communication is disengaged. The conditions may include in particular that the wired communication detector 238 detects that the wired network adapter 104 is in communication with a wired network 110, and an event registration control 234 detects an event. In another embodiment, the conditions may include that the wireless network adapter 106 is enabled.

FIG. 2 illustrates a wireless network adapter 206 coupled to the controller 218 and configured to provide a wireless connection between the device 202 and a wireless network 114 (see FIG. 1). Also depicted is a wired network adapter 204 coupled to the controller 218 and configured to provide a wired connection between the device 202 and the wired network 110.

The CPU 216 of the device 202 further includes a memory 230 and modules 232. Modules may include, for example, an event handler module 256 that can include instructions configured to detect a plurality of events. Another module may include a netchange module 278 including instructions configured to at least partially disable the wireless network adapter 206 when the wired network adapter 204 is enabled and the event handler module 256 detects a registered event. The modules can carry out certain processes of the methods as described herein. The modules can be implemented in software, such as in the form of one or more sets of prestored instructions, and/or hardware, which can facilitate the operation of the mobile station or electronic device as discussed below. The modules may be installed at the factory or can be installed after distribution by, for example, a downloading operation. The operations in accordance with the modules will be discussed in more detail below.

As described above, an event registration control 234 such as an event handler module 256 may detect a plurality of registered events. Events may include at least one of power up of the device 202, resuming operation of the device 202 from hibernation, resuming operation of the device 202 from standby, a predetermined task startup, or a user defined predetermined event and any other type of event. It is understood that any event that does not add additional background processing is within the scope of this discussion. Predefined and/or default events may be registered with the event registration control 234. In addition, events may be registered with the event registration control via the user interface 220 and the user interface control 236, that is, the user defined event may be processed via the user interface control 236 coupled to the user interface 220. The user defined event may be, for example, an activation of an icon or a menu selection to activate the wireless network connection. In this manner, the trigger for disabling the wireless network adapter 206 is based on the status of the network adapter 204 and a pre-defined event.

When the above-described conditions are met, a wireless adapter disengagement control 242 is configured to disengage at least most of the wireless communication. That is, the wireless network adapter 106 need not be entirely disabled when at least most of the wireless communication is disengaged. In an embodiment the wireless adapter disengagement control 242 is configured to disengage all wireless communication, that is, to turn off any communication via the wireless transceiver 112 (see FIG. 1) and/or disable the wireless network adapter 206. In this manner, the wireless adapter disengagement control 242 may provide for reducing or eliminating background processing associated with wireless communication, and thus may provide for reduced system processing. Moreover, the wireless adapter disengagement control 242 may provide for reduced power consumption. As discussed above, an alert control 222 may be coupled to the controller 218, the alert control 222 configured for notification 124 (see FIG. 1) of the disengagement from the wireless network 114 and/or disabling of the wireless network adapter 106 to inform the user that the wireless connection has been disengaged/disabled.

There may be a situation where the wired connection 108 (see FIG. 1) is disconnected and a user may wish the wired connection 108 established. For example, a user may wish to move the location of the device 202. Accordingly, it may be beneficial to have a wireless adapter engagement control 244 configured to enable the wireless network adapter 206 or transceiver 112 when the wired connector detector 238 detects that the wired communication connector 108 is not in communication with a wired network 110. It may be beneficial that an alert control 222 coupled to the controller 218 is further configured to notify the user that the wireless adapter engagement control 244 of the wireless network adapter 106 has been activated. Additionally, a manual override control 246 may allow the user to maintain the wireless connection 112 with the wireless network 114 by deactivating the wireless adapter disengagement control 242 coupled to the controller 218 even when the device 202 is in wired communication 108 with the wired network 110.

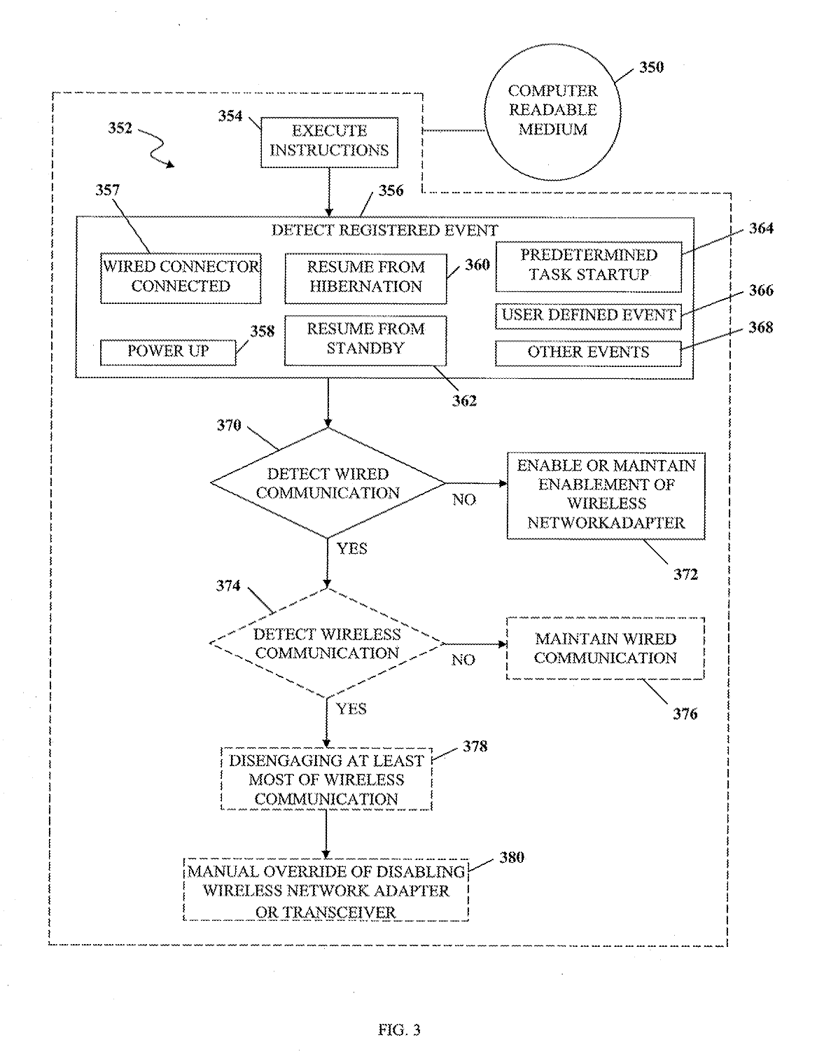

FIG. 3 depicts a method including that of a computer readable medium 350 having computer executable instructions for performing a method 352 of an electronic device 102 (see FIG. 1) including a controller 218 (see FIG. 2), a wireless communication transceiver 112 coupled to the controller 218, and a wired communication connector 108 coupled to the controller 218. The method of FIG. 3 may be in the form of software or hardware instructions stored on a computer readable medium 350, and/or may be, for example, downloaded to a device 102 in any suitable manner. Upon execution 354 of the instructions, the instructions can include detecting 356 an event including at least one of connecting 357 a wired network connector to the device 102, power up 358 of the device, resuming operation 360 of the device from hibernation, resuming operation 362 of the device from standby, initiating 364 a predetermined task startup, initiating 366 a user-defined predetermined event, or initiating 368 other events. An event handler module 156 can include instructions configured to detect a plurality of events.

Upon detecting an event 356, the method also includes detecting 370 that the wired communication connector 108 (see FIG. 1) is in communication with a wired network 110. If there is no wired communication, enablement of the wireless network adapter may be maintained 372. If there is a wired communication, the method may optionally include detecting 374 whether there is wireless communication with a wireless network. If there is no wireless communication detected, the method may include maintaining 376 the wired communication. As discussed above, when both a wired and wireless communication are activated, the method may include disengaging 378 at least most of the wireless communication. That is, the wireless network adapter 106 (see FIG. 1) need not be entirely disabled when at least most of the wireless communication is disengaged. A netchange module 178 has instructions configured to disable the wireless network adapter 106 when the wireless network adapter 106 is enabled. In an embodiment, the netchange module 178 has instructions configured to at least partially disable the wireless network adapter 106 when the wireless network adapter is enabled. As mentioned above, there may be a reason that the user wishes to manually override 380 disabling the wireless network adapter 106 or transceiver 112.

The above-discussed devices, methods, and computer readable media including instructions for a method provide that when a device is in wired communication with a network, that a wireless network adapter of the device is not simultaneously enabled. Accordingly, the user need not manually disable the wireless network adapter. A user may prefer the communication to take place over a wired network since it is faster and has a higher bandwidth than a wireless connection, and otherwise probably would not have made the wired connection by plugging in a cable to the device. The device and methods may automatically ignore connections changes for example, from VPNs and USB network devices. Accordingly, the wireless network resources may be conserved.

An event is a trigger for determining whether the device is in communication with a wired network. The conditions may avoid a device consuming system resources associated with wireless communication if its wired connector is in communication with a wired network. It is understood that the system automatically determines which connections are wired and which are wireless. By using an event as a trigger for the determination of whether the device is in communication with a wired network, the disclosed devices and method beneficially do not add any additional background processes to the operation of the device, thus conserving processing resources. Beneficially, the disclosed methods do not require additional configuration to the device since the described devices typically include an automatic wireless adapter switch which may be utilized in accordance with the above-described devices and methods.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) was chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally and equitably entitled.

1. An electronic device, comprising:
a controller;
an event registration control coupled to the controller that is configured to detect at least one of a plurality of registered events;
a wireless network adapter coupled to the controller;
a wired communication connector coupled to the controller;
a wired communication detector that is configured to detect when the wired communication connector is in communication with a wired network; and
a wireless adapter disengagement control that is configured to disable the wireless network adapter when the wired communication detector detects that the wired communication connector is in communication with a wired network and the event registration control detects a registered event.

2. The electronic device of claim 1, wherein:
the wireless network adapter is configured to engage in wireless communication with a wireless network; and
the wireless adapter disengagement control is further configured to disengage at least most of the wireless communication when the wired communication detector detects that the wired communication connector is in communication with a wired network and the event registration control detects a registered event.

3. The electronic device of claim 1, wherein a registered event of the event registration control includes detection of connection of the wired communication connector to a wired network.

4. The electronic device of claim 1, wherein a registered event of the event registration control includes power up of the device.

5. The electronic device of claim 1, wherein a registered event of the event registration control includes resuming operation of the device from hibernation.

6. The electronic device of claim 1, wherein a registered event of the event registration control includes resuming operation of the device from standby.

7. The electronic device of claim 1, wherein a registered event of the event registration control includes a predetermined task startup.

8. The electronic device of claim 1, further comprising:
a manual override control of the wireless adapter disengagement control, the manual override control coupled to the controller.

9. The electronic device of claim 1, further comprising:
an alert control coupled to the controller, the alert control configured for notification that the wireless adapter disengagement control has been activated.

10. The electronic device of claim 1, further comprising:
an engagement control configured to enable the wireless network adapter when the wired connector detector detects that the wired communication connector is not in communication with a wired network.

11. The electronic device of claim 10, further comprising:
an alert control coupled to the controller, the alert control configured for notification that the engagement control has been activated.

12. The electronic device of claim 1, further comprising:
a user interface coupled to the controller configured to receive input to form user defined predetermined events to which the event registration control is responsive.

13. The electronic device of claim 1 is a computer.

14. An electronic device, comprising:
a controller configured to execute instructions;
a memory coupled to the controller and configured to store instruction modules;
an event handler module having instructions configured to detect a plurality of registered events;
a wireless network adapter coupled to the controller and configured to provide a wireless connection between the device and a network;
a wired network adapter coupled to the controller and configured to provide a wired connection between the device and the network and configured to notify the event handler when the wired network adapter is connected; and
a netchange module having instructions configured to at least partially disable the wireless network adapter when the event handler module detects at least one registered event and that the wired network adapter is connected.

15. The electronic device of claim 14, wherein the event handler is configured to detect at least one of power up of the device, resuming operation of the device from hibernation, resuming operation of the device from standby, a predetermined task startup, or a user defined predetermined event.

16. The electronic device of claim 14, wherein:
the wired network adapter is further configured to notify the event handler when the wired network adapter is not connected; and
the netchange module is configured to enable the wireless network adapter when the event handler detects an event that the wired network adapter is not connected.

17. A method of an electronic device including a controller, a wireless network adapter coupled to the controller, and a wired communication connector coupled to the controller, the method comprising:
detecting an event registered with an event registration control, the event including at least one of power up of the device, resuming operation of the device from hibernation, resuming operation of the device from standby, a predetermined task startup, or a user defined predetermined event;
detecting when the wired communication connector is in communication with a wired network; and
disabling the wireless network adapter when both detecting that the wired communication connector is in communication with a wired network and detecting an event registered with the event registration control.

18. The method of claim 17, further comprising:
manually overriding disabling the wireless network adapter.

19. The method of claim 17, further comprising:
enabling the wireless network adapter when detecting that the wired communication connector is not in communication with a wired network.

20. A computer readable medium having computer executable instructions for performing a method of an electronic device including a controller, a wireless network adapter coupled to the controller, and a wired communication connector coupled to the controller, the method comprising:
detecting an event registered with an event registration control, the event including at least one of power up of the device, resuming operation of the device from hibernation, resuming operation of the device from standby, a predetermined task startup, or a user defined predetermined event;
detecting when the wired communication connector is in communication with a wired network; and
disabling the wireless network adapter when both detecting that the wired communication connector is in communication with a wired network and detecting an event registered with the event registration control.
